(19) United States
(12) Patent Application Publication
(10) Pub. No.: US 2019/0014723 A1
(43) Pub. Date: Jan. 17, 2019

(54) SYSTEM AND METHOD FOR AVOIDING OBSTACLE COLLISIONS WHEN ACTUATING WING ASSEMBLIES OF AN AGRICULTURAL IMPLEMENT

(71) Applicant: CNH Industrial America, LLC, New Holland, PA (US)

(72) Inventors: TREVOR STANHOPE, Darien, IL (US); CHRISTOPHER A. FOSTER, Mohnton, PA (US); KEVIN M. SMITH, Narvon, PA (US)

(73) Assignee: CNH Industrial America, LLC

(21) Appl. No.: 15/651,115

(22) Filed: Jul. 17, 2017

(51) Int. Cl. A01D 75/18; A01B 73/04; G01S 13/93; G06K 9/00

(52) U.S. Cl. CPC A01D 75/185; G06K 9/00805; G01S 13/931; A01B 73/042

(57) ABSTRACT

A method for avoiding collisions when actuating wing assemblies of an agricultural implement may include accessing vision-related data associated with an obstacle collision zone for the agricultural implement and determining whether a wing movement operation can be executed without collision between the agricultural implement and an obstacle based at least in part on the vision-related data. The wing movement operation is associated with moving a wing assembly of the agricultural implement across at least a portion of the obstacle collision zone between a work position of the wing assembly and a transport position of the wing assembly. Additionally, when it is determined that the wing movement operation can be executed without collision, the method may include actively controlling an operation of at least one component configured to facilitate initiation of the wing movement operation.

### FIELD OF THE INVENTION

The present subject matter relates generally to systems and methods for performing automatic wing movement operations for agricultural implements and, more particularly, to system and methods for avoiding obstacle collisions when actuating a wing assembly of an agricultural implement.

### BACKGROUND OF THE INVENTION

A wide range of farm implements have been developed and are presently in use for tilling, planting, harvesting, and so forth. Seeders or planters, for example, are commonly towed behind tractors and may cover wide swaths of ground which may be tilled or untilled. Such devices typically open the soil, dispense seeds in the opening, and reclose the soil in a single operation. Seeds are commonly dispensed from seed tanks and distributed to row units by a distribution system. To make the seeding operation as efficient as possible, very wide swaths may be covered by extending wing assemblies on either side of a central frame section of the implement being pulled by the tractor. Typically, each wing assembly includes one or more toolbars, various row units mounted on the toolbar(s), and one or more associated support wheels. The wing assemblies are commonly disposed in a “floating” arrangement during the planting operation, wherein hydraulic cylinders allow the implement to contact the soil with sufficient force to open the soil, dispense the seeds, and subsequently close the soil. For transport, the wing assemblies are elevated by the support wheels to disengage the row units from the ground and may optionally be folded, stacked, and/or pivoted to reduce the width of the implement.

To transition the wing assemblies from the transport position to the work position, a wing movement operation is performed in which the assemblies are moved via control of the operation of the associated hydraulic cylinders to allow the wing assemblies to be unfolded relative to the central frame section of the implement and subsequently lowered relative to the ground. A reverse operation may be performed to transition the wing assemblies from the work position to the transport position in which the wing assemblies are raised relative to the ground and subsequently folded towards the central frame section of the implement. Given the potential for damage to the implement and/or to address any safety issues associated with obstacle collisions, current practices mandate that all implement folding operations be carried out manually by the vehicle operator. However, such manually-driven operations present a significant obstacle to further developing and enhancing the autonomous functionality of tractors and associated implements.

Accordingly, a system and related methods for allowing automatic wing movement operations to be performed while avoiding obstacle collisions would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for avoiding collisions when actuating wing assemblies of an agricultural implement. The method may include accessing, with one or more computing devices, vision-related data associated with an obstacle collision zone for the agricultural implement and determining, with the one or more computing devices, whether a wing movement operation can be executed without collision between the agricultural implement and an obstacle based at least in part on the vision-related data. The wing movement operation is associated with moving a wing assembly of the agricultural implement across at least a portion of the obstacle collision zone between a work position of the wing assembly and a transport position of the wing assembly. Additionally, when it is determined that the wing movement operation can be executed without collision, the method may include actively controlling, with the one or more computing devices, an operation of at least one component configured to facilitate initiation of the wing movement operation.

In another aspect, the present subject matter is directed to a system for avoiding collisions when actuating implement wing assemblies. The system may include an agricultural implement including at least one wing assembly configured to be moved between a work position and a transport position. The system may also include at least one vision sensor configured to acquire vision-related data associated with an obstacle collision zone for the agricultural implement and a controller communicatively coupled to the vision sensor. The controller may include a processor and associated memory. The memory may store instructions that, when executed by the processor, configure the controller to access the vision-related data received from the vision sensor and determine whether a wing movement operation can be executed without collision between the agricultural implement and an obstacle based at least in part on the vision-related data. The wing movement operation is associated with moving the wing assembly across at least a portion of the obstacle collision zone defined between the work and transport positions. Additionally, when it is determined that the wing movement operation can be executed without collision, the controller may be configured to actively control an operation of at least one component configured to facilitate initiation of the wing movement operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a work vehicle towing an implement in accordance with aspects of the present subject matter;

FIG. 2 illustrates a perspective view of the implement shown in FIG. 1, particularly illustrating wing assemblies of the implement located at their compact transport position;

FIG. 3 illustrates another perspective view of the implement shown in FIG. 2, particularly illustrating the wing assemblies located at their work position;

FIG. 4 illustrates a schematic view of one embodiment of a system for avoiding obstacle collisions when actuating wing assemblies of an agricultural implement in accordance with aspects of the present subject matter;

FIG. 5 illustrates a schematic view of a specific implementation of the system shown in FIG. 4;

FIG. 6 illustrates a flow diagram of one embodiment of a method for avoiding obstacle collisions when actuating wing assemblies of an agricultural implement in accordance with aspects of the present subject matter;

FIG. 7 illustrates a flow diagram of a specific implementation of the method shown in FIG. 6 when operating in an operator-supervised mode; and

FIG. 8 illustrates a flow diagram of another specific implementation of the method shown in FIG. 6 when operating in an unsupervised or automated mode.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for avoiding obstacle collisions when actuating wing assemblies of an agricultural implement. Specifically, in several embodiments, one or more vision sensors of the system (e.g., one or more cameras, radar devices, LIDAR devices, ultrasound sensors, and/or the like) may be configured to capture or otherwise acquire vision-related data associated with an obstacle collision zone for the implement. The vision-related data collected from the vision sensor(s) may then be analyzed or assessed to determine whether any obstacles are present within the implement's obstacle collision zone that would be collided with or against when actuating one or more wing assemblies of the implement to perform a desired or requested wing movement operation (e.g., folding/unfolding of the wing assemblies and/or raising/lowering of the wing assemblies). In one embodiment, the vision-related data may be transmitted by a controller of the disclosed system for presentation on a display device accessible to an operator of the system. In such an embodiment, the operator may visually assess the vision-related data to determine whether any obstacles are present within the implement's obstacle collision zone. Alternatively, the vision-related data may be automatically analyzed by the controller using a suitable computer-vision technique that allows for the detection of obstacles within the data. Regardless, in the event that it is determined that the obstacle collision zone of the implement is free from obstacles, the controller may be configured to control the operation of the implement (e.g., by controlling the implement's actuators) and/or the work vehicle (e.g., by controlling the vehicle's actuators) to execute the desired or requested wing movement operation.

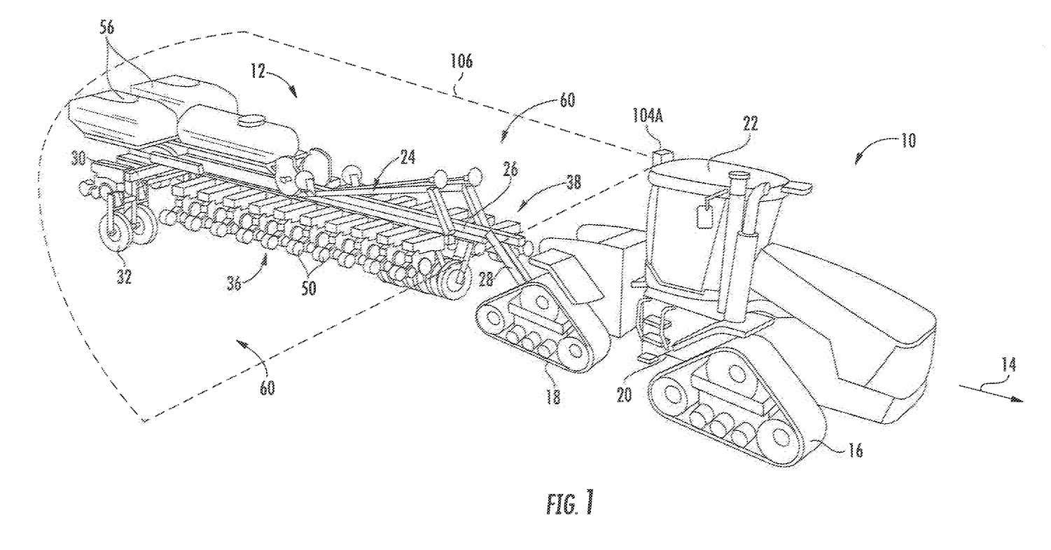

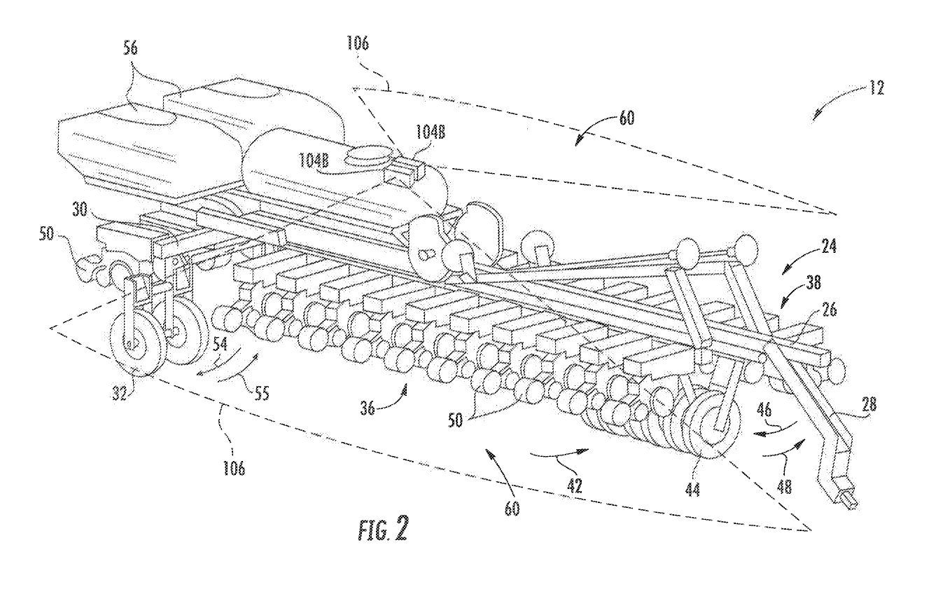

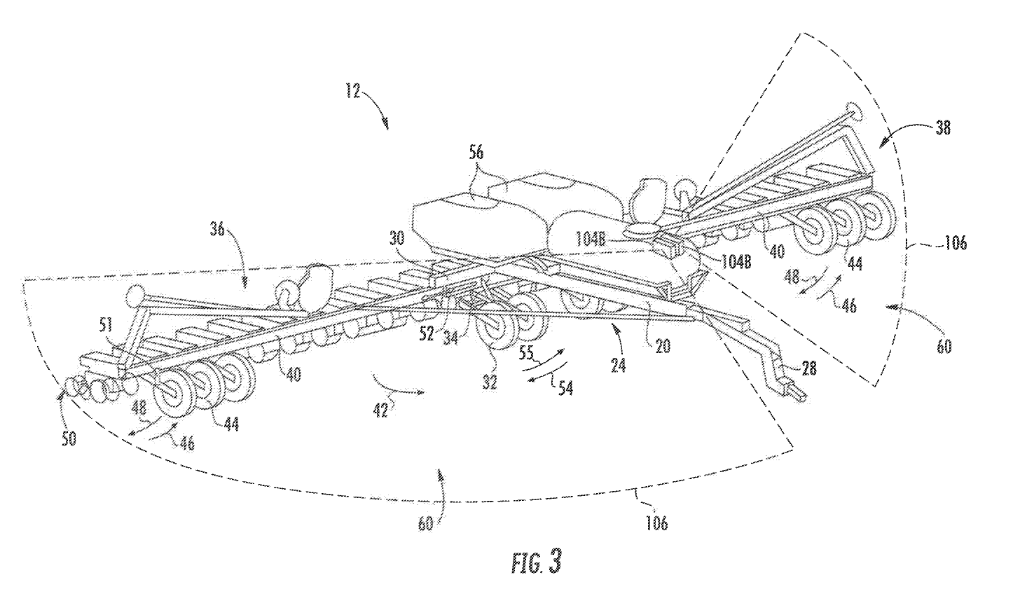

Referring now to the drawings, FIGS. 1-3 illustrate several views of one embodiment of a work vehicle 10 and an associated agricultural implement 12 are illustrated in accordance with aspects of the present subject matter. Specifically, FIG. 1 illustrates a perspective view of the work vehicle 10 towing the implement 12 along a direction of travel (e.g., as indicated by arrow 14), with the implement 12 being folded-up into a compact transport position. Additionally, FIG. 2 illustrates a perspective view of the implement 12 shown in FIG. 1 while FIG. 3 illustrates a perspective view of the implement 12 shown in FIGS. 1 and 2 after the implement 12 has been unfolded and lowered to its work position. As shown in the illustrated embodiment, the work vehicle 10 is configured as an agricultural tractor. However, in other embodiments, the work vehicle 10 may be configured as any other suitable agricultural vehicle.

As particularly shown in FIG. 1, the work vehicle 10 includes a pair of front track assemblies 16, a pair or rear track assemblies 18 and a frame or chassis 20 coupled to and supported by the track assemblies 16, 18. An operator's cab 22 may be supported by a portion of the chassis 20 and may house various input devices for permitting an operator to control the operation of one or more components of the work vehicle 10 and/or one or more components of the implement 12. Additionally, as is generally understood, the work vehicle 10 may include an engine (not shown) and a transmission (not shown) mounted on the chassis 20. The transmission may be operably coupled to the engine and may provide variably adjusted gear ratios for transferring engine power to the track assemblies 16, 18 via a drive axle assembly (not shown) (or via axles if multiple drive axles are employed).

As particularly shown in FIGS. 2 and 3, the implement 12 may, in one embodiment, correspond to a planter. However, in other embodiments, the implement 12 may correspond to any other suitable agricultural implement, such as a tillage implement. As shown in the illustrated embodiment, the implement 12 may generally include a frame assembly 24 configured to be towed by the work vehicle 10 via a tow bar 26 in the travel direction 14 of the vehicle 10. For instance, the implement 12 may include a hitch assembly 28 coupled to the tow bar 26 that allows the implement 12 to be coupled to the work vehicle 10.

As shown in FIGS. 2 and 3, the frame assembly 24 of the implement 12 may include a central frame section or toolbar 30 extending lengthwise generally transverse to the tow bar 26. Additionally, a central wheel assembly 32 may be disposed below and coupled to the central toolbar 30. As is generally understood, the central wheel assembly 32 may include an actuator 34 (e.g., a hydraulic cylinder) configured to extend (e.g., in direction indicted by arrow 54) and retract (e.g., in direction indicated by arrow 55) the wheel assembly 32 relative to the ground. For example, the actuator 34 may be configured to extend the wheel assembly 32 towards the ground when moving the implement 12 to its compact transport position (e.g., as shown in FIG. 2). Additionally, the actuator 34 may be configured to retract the central wheel assembly 32 relative to the ground when moving the implement 12 to its ground engaging or work position (e.g., as shown in FIG. 3).

Moreover, the frame assembly 24 may also include first and second wing assemblies 36, 38 disposed along each side of central toolbar 30. In general, each wing assembly 36, 38 may include a wing toolbar 40 (FIG. 3) pivotally coupled to the central tool bar 30 to allow the toolbar 40 to be folded in a forward direction (e.g., as indicated by arrow 42) when transitioning the wing assemblies 36, 38 from their work position to their compact transport position. When in the compact transport position (FIG. 2), the wing toolbars 40 may be configured to extend generally perpendicular to the central toolbar 30 and generally parallel to the tow bar 26.

As shown in FIGS. 2 and 3, each wing assembly 36, 38 may also include one or more wing wheel assemblies 44 to facilitate lifting the wing toolbars 40 relative to the ground, thereby allowing the wing assemblies 36, 38 to be folded to their final compact transport position. For example, the wing wheel assemblies 44 may be configured to be retracted in a retraction direction (indicated by arrow 46) to lower the wing toolbars 40 to the work position. Similarly, the wing wheel assemblies 44 may be configured to be extended in an opposite extension direction (indicated by arrow 48) to move the wing assemblies 36, 38 from the work position to a raised transport position. Specifically, as the wing wheel assemblies 44 are extended in the extension direction 48, ground-engaging tools, such as row units 50 of the wing assemblies 36, 38, may be elevated to a location above the ground, thereby raising each wing assembly 36, 38 from its work position to its raised transport position. It should be appreciated that the extension and retraction of the wing wheel assemblies 44 may be controlled, for example using suitable actuators 51 (e.g., hydraulic cylinders) coupled between each wing wheel assembly 44 and the adjacent wing toolbar 40.

As shown in the illustrated embodiment, wing actuators 52, such as hydraulic cylinders, may be coupled between each wing toolbar 40 and the tow bar 26 (and/or between each wing toolbar 40 and the central toolbar 30) to facilitate folding of the wing toolbars 40 relative to the central toolbar 30. For example, in one embodiment, at least one wing actuator 52 may be attached to each of the two wing toolbars 40 in order to control the folding movement of the wing assemblies 36, 38. As is generally understood, each end of each wing actuator 52 may be connected to its respective component by a pin or other pivoting joint.

In one embodiment, the wing wheel assemblies 44 may be extended while the wing assemblies 36, 38 are folded forward toward the tow bar 26. Additionally, when the wing tool bars 40 are fully folded, the toolbars 40 may be elevated over the tow bar 26. The wing wheel assemblies 44 may then be retracted, thereby enabling the wing toolbars 40 to lock to the tow bar 26 and allowing the wheels 44 to interleave in a manner that reduces the overall width of the implement 12 when in the compact transport position. Similarly, as the wing wheel assemblies 44 are retracted, the central wheel assembly 32 may be extended in an extension direction (e.g., as indicated by arrow 54) to elevate the implement 12 into transport mode. When interleaved, the wing wheel assemblies 44 may include at least one opposing tool bar wheel adjacent to that wing's wheel. Specifically, the wheel assemblies 44 from opposite sides may face one another in staggered positions as the tool bars 40 fold toward one another in the forward folding direction 42. As such, when wing assemblies 36, 38 are fully folded to their compact transport position, the wheel assemblies 44 may be least partially or entirely overlapping in a row such that the wheel assemblies 44 alternate from the first wing assembly 26 to the second wheel assembly 38.

As indicated above, each wing assembly 36, 38 may include a plurality of row units 50 supported by its respective wing toolbars 40. In general, the row units 50 may be configured to dispense seeds along parallel rows and at a desired spacing along the field. Depending on the design of the row units 50 and any other suitable factors, such as the nature of the field (e.g., tilled or untilled), each row unit 50 may serve a variety of functions and, thus, may include any suitable structures and/or components for performing these functions. Such components may include, for example, an opening disc, a metering system, a covering disc, a firming wheel, a fertilizer dispenser, and so forth. In one embodiment, recipients or hoppers may be mounted on the framework of each row unit 50 for receiving seeds, fertilizer or other materials to be dispensed by the row units. In addition to such hoppers (or as an alternative thereto), a distribution system may serve to communicate seeds from one or more seed tanks 56 to the various row units 50.

It should be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration. For example, in an alternative embodiment, a separate frame or chassis may be provided to which the engine, transmission, and drive axle assembly are coupled, a configuration common in smaller tractors. Still other configurations may use an articulated chassis to steer the work vehicle 10, or rely on tires/wheels in lieu of the track assemblies 16, 18. Additionally, although the work vehicle 10 is shown in FIG. 1 as including a cab 22 for an operator, the work vehicle 10 may, instead, correspond to an autonomous vehicle, such as an autonomous tractor.

It should also be appreciated that the configuration of the implement 12 described above and shown in FIGS. 1-3 is only provided for exemplary purposes. Thus, it should be appreciated that the present subject matter may be readily adaptable to any manner of implement configuration. In particular, the present subject matter may be applicable to any suitable implement having wing assemblies configured to be actuated between a work position, at which the ground-engaging tools of the wing assemblies engage the ground, and a transport position, at which the ground-engaging tools of the wing assemblies are elevated above the ground. For example, as an alternative to implement configuration shown in FIGS. 1-3, the implement 12 may include two or more wing assemblies disposed along each side of the central toolbar 30, with each wing assembly being configured to be folded relative to the central toolbar 30 (and/or relative to an adjacent wing assembly) between a work position and a transport position.

Additionally, in accordance with aspects of the present subject matter, the work vehicle 10 and/or the implement 12 may include one or more vision sensors 104 coupled thereto and/or supported thereon for capturing images or other vision-related data associated with a view of the implement 12 and/or the area surrounding the implement 12. Specifically, in several embodiments, the vision sensor(s) 104 may be provided in operative association with the work vehicle 10 and/or the implement 12 such that the vision sensor(s) 104 has a field of view directed towards all or a portion of the potential “obstacle contact zone” (generally indicated by arrow 60) defined along the range of travel of each wing assembly 36, 38 between its work position and its transport position (e.g., the compact transport position shown in FIG. 2). As used herein, the term “obstacle contact zone” generally corresponds to the combined volume of space across which the wing assemblies 36, 38 (e.g., including the wing toolbars 40, the row units 50, the wing wheel assemblies 44 and/or any other suitable components supported by the toolbars 40) are traversed when the implement 12 is stationary and each wing assembly 36, 38 is moved from its work position to its transport position or vice versa. As such, if an obstacle (e.g., a person, animal, tree, utility pole, and/or any other object) is located within the obstacle contact zone 60 defined for the implement 12, such obstacle will be contacted by a portion of the implement 12 as each wing assembly 36, 38 is moved between its work and transport positions. Thus, by configuring the work vehicle 10 and/or the implement 12 to include one or more vision sensors 104 having a field of view that encompasses all or at least a substantial portion of the obstacle contact zone 60 for the implement 12, the vision sensor(s) 104 may be configured to detect any obstacles located within such contact zone 60.

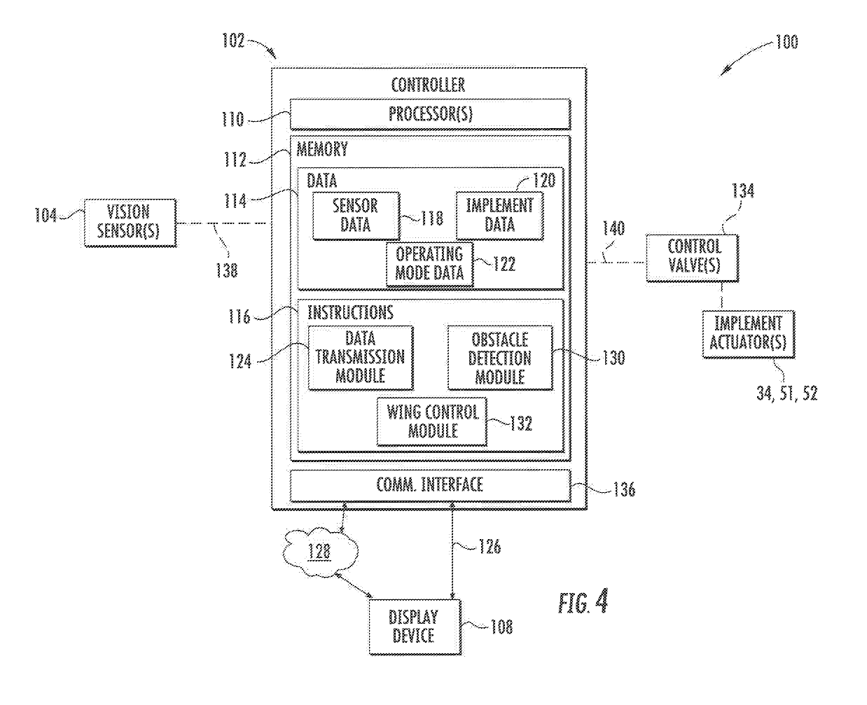

As will be described below with reference to FIG. 4, the vision-related data acquired by the vision sensor(s) 104 may be utilized in accordance with aspects of the present subject for determining whether to perform a wing movement operation associated moving the wing assemblies 36, 38 between the work and transport positions. For example, in several embodiments, a request may be received by a controller of the disclosed system from a local or remote operator of the system that is associated with moving the wing assemblies 36, 38 along all or a portion of the travel range defined between their work and transport positions, such as a request to perform a complete folding operation to move the wing assemblies 36, 38 from their work position to their compact transport position, a request to perform a complete unfolding operation to move the wing assemblies 36, 38 from their compact transport position to their work position, and/or a request to perform any other operation associated with moving the wing assemblies 36, 38 between their work and transport positions (e.g., a request to raise the wing assemblies 36, 38 relative to the ground from their work position to their raised transport position and/or a request to lower the wing assemblies 36, 38 relative to the ground from their raised transport position to their work position). In such embodiments, the system controller may be configured to automatically analyze the vision-related data acquired by the vision sensor(s) 104 and/or transmit such data to a display device or any other associated electronic device accessible to the operator. The controller and/or the operator may then determine whether any obstacles are present within the portion of the obstacle contact zone 60 to be traversed by the wing assemblies 36, 38 when performing the requested operation. In the event that an obstacle is present within the relevant portion of the obstacle contact zone 60, it may be determined by the controller (e.g., either automatically or via input from the operator) that the requested operation should not be performed or should be terminated (assuming that the operation had already been initiated upon detection of the obstacle).

In general, the vision sensor(s) 104 may correspond to any suitable device(s) configured to acquire images or other vision-related data associated with all or a portion of the obstacle contact zone 60 for the implement 12. For instance, in several embodiments, the vision sensor(s) 104 may correspond to any suitable camera(s), such as single-spectrum camera or a multi-spectrum camera configured to capture images in the visible light range and/or infrared spectral range. In a particular embodiment, the camera(s) may correspond to a single lens camera configured to capture two-dimensional images or a stereo camera(s) having two or more lenses with a separate image sensor for each lens to allow the camera(s) to capture stereographic or three-dimensional images. Alternatively, the vision sensor(s) 104 may correspond to any other suitable device(s) that is capable of acquiring “images” or other vision-related data of the obstacle contact zone 60 for the implement 12, such as a radar sensor (e.g., a scanning or stationary radar device), a Light Detection and Ranging (LIDAR) device (e.g., a scanning or stationary LIDAR device), an ultrasound sensor and/or any other suitable vision-based sensing device.

It should be appreciated that the work vehicle 10 and/or implement 12 may include any number of vision sensor(s) 104 provided at any suitable location that allows vision-related data of the implement's obstacle contact zone 60 to be captured or otherwise acquired by the sensor(s) 104. For instance, FIGS. 1-3 illustrate examples of locations for installing one or more vision sensor(s) 104 in accordance with aspects of the present subject matter. Specifically, as shown in FIG. 1, in one embodiment, one or more vision sensors 104A may be coupled to the aft of the work vehicle 10 such that the sensor(s) 104A has a field of view 106 that allows it to acquire images or other vision-related data of all or substantially all of the implement's obstacle contact zone 60. For instance, the field of view 106 of the sensor(s) 104A may be directed outwardly from the aft of the work vehicle 10 along a plane or reference line that extends generally parallel to the travel direction 14 of the work vehicle 10 such that the sensor(s) 104 is capable of acquiring vision-related data associated with the implement 12 and the area(s) surrounding the implement 12 (e.g., the area(s) encompassing the obstacle contact zone 60). In such an embodiment, a single vision sensor(s) 104A may be used that has a sufficiently wide field of view to enable vision-related data to be acquired of all or substantially all of the implement's obstacle contact zone 60. Alternatively, two or more vision sensor(s) 104A may be installed on the work vehicle 10, such as by installing a first vision sensor configured to acquire vision-related data associated with the portion of the obstacle contact zone 60 traversed by the first wing assembly 36 and a second vision sensor configured to acquire vision-related data associated with the portion of the obstacle contact zone 60 traversed by the second wing assembly 38.

As shown in FIGS. 2 and 3, in addition the vehicle-mounted vision sensor(s) 104A or as an alternative thereto), one or more vision sensors 104B may be coupled to a portion of the implement 12 such that the vision sensor(s) 104B has a field of view 106 that allows it to acquire images or other vision-related data of all or substantially all of the implement's obstacle contact zone 60. For instance, the field of view 106 of the vision sensor(s) 104B may be directed outwardly from the implement 12 towards the wing assemblies 36, 38 (and/or the area traversed by the wing assemblies 36, 38 when being moved between their work and transport positions). In such an embodiment, a single vision sensor(s) 104B may be used that has a sufficiently wide field of view to enable vision-related data to be acquired of all or substantially all of the implement's obstacle contact zone 60. Alternatively, two or more vision sensor(s) 104B may be installed on the implement 12, such as by installing a first vision sensor configured to acquire vision-based data associated with the portion of the obstacle contact zone 60 traversed by the first wing assembly 36 and a second vision sensor configured to acquire vision-related data associated with the portion of the obstacle contact zone 60 traversed by the second wing assembly 38.

Referring now to FIG. 4, a schematic view of one embodiment of a system 100 for avoiding obstacle collisions when actuating wing assemblies of an agricultural implement is illustrated in accordance with aspects of the present subject matter. In general, the system 100 will be described herein with reference to the work vehicle 10 and the implement 12 described above with reference to FIGS. 1-3. However, it should be appreciated that the disclosed system 100 may generally be utilized with work vehicles having any suitable vehicle configuration and/or implements have any suitable implement configuration.

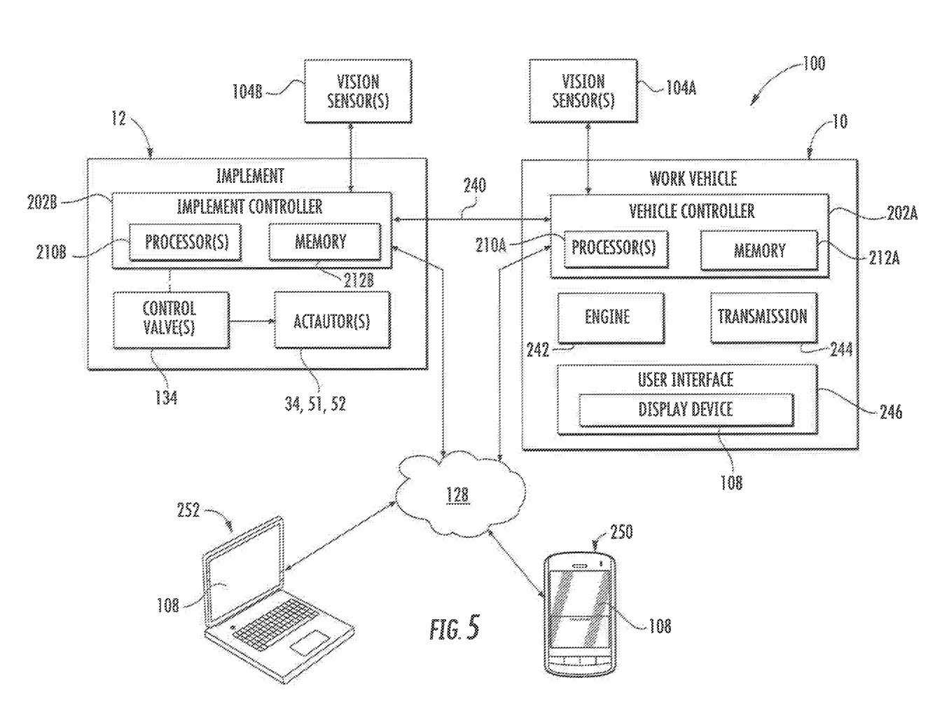

It should also be appreciated that the various features of the embodiment of the system 100 shown in FIG. 4 will be described generally with reference to a single computing device or controller. However, in alternative embodiments, the various databases, modules, and/or the like may be distributed across multiple computing devices to allow two or more computing devices to execute the functions and/or other related control actions of the disclosed system 100 (and the related methods). For instance, as will be described below with reference to FIG. 5, the various databases, modules, and/or control functions described herein with reference to FIG. 4 may, for example, be distributed between a vehicle controller 202A of the work vehicle 10 and an implement controller 202B of the implement 12.

In several embodiments, the system 100 may include a controller 102 and various other components configured to be communicatively coupled to and/or controlled by the controller 102, such as one or more vision sensors 104 and/or various other components of the work vehicle 10 and/or the implement 12. As will be described in greater detail below, the controller 102 may be configured to acquire vision-related data from the vision sensor(s) 104 that is associated with a field of view encompassing all or a portion of the obstacle collision zone 60 for the implement 12. Thereafter, when a request is received from the operator to perform an operation related to moving the wing assemblies 36, 38 of the implement 12, the controller 102 may be configured to process and/or analyze the data to allow a determination to be made as to whether such operation can be performed without resulting in a collision between a portion of the implement 12 and one or more obstacles. For example, in one embodiment, the controller 102 may be configured to transmit the vision-related data for presentation to the operator on an associated display device 108 (e.g., a display device located within the cab 22 of the work vehicle 10 or a display device provided in operative association with a separate computing device, such as a handheld electronic device or a remote computing device otherwise accessible to the operator). In such an embodiment, the operator may be allowed to view the vision-related data and make a determination as to whether the operation should be initiated. The operator may then provide a suitable input to the controller 102 associated with his/her determination. Alternatively, the controller 102 may be configured to automatically analyze the vision-related data using a suitable computer-vision technique, such as by using an image processing algorithm. Based on the analysis of the data, the controller 102 may then automatically determine whether the requested operation can be performed without resulting in a collision between a portion of the implement 12 and a given obstacle. In the event that it is determined that the requested operation can be performed without collision (e.g., due to the relevant portion of the implement's obstacle collision zone 60 being free of obstacles), the controller 102 may be configured to initiate the operation in order to actuate or move the wing assemblies 36, 38 as requested.

In general, the controller 102 may correspond to any suitable processor-based device(s), such as a computing device or any combination of computing devices. Thus, as shown in FIG. 4, the controller 102 may generally include one or more processor(s) 110 and associated memory devices 112 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 112 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 112 may generally be configured to store information accessible to the processor(s) 110, including data 114 that can be retrieved, manipulated, created and/or stored by the processor(s) 110 and instructions 116 that can be executed by the processor(s) 110.

In several embodiments, the data 114 may be stored in one or more databases. For example, the memory 112 may include a sensor database 118 for storing vision-related data received from the vision sensor(s) 104. For example, the vision sensor(s) 104 may be configured to continuously or periodically (e.g., on-demand) capture vision-related data associated with all or a portion of the obstacle collision zone 60 of the implement 12. In such an embodiment, the data transmitted to the controller 102 from the vision sensor(s) 104 may be stored within the sensor database 118 for subsequent processing and/or analysis. It should be appreciated that, as used herein, the term vision-related data may include, but is not limited to, any suitable type of data received from the vision sensor(s) 104 that allows for the area encompassed within and/or surrounding the implement's obstacle collision zone 60 to be analyzed or assessed (e.g., either manually by the operator or automatically via a computer-vision technique).

Additionally, as shown in FIG. 4, the memory 112 may include an implement database 120 for storing relevant information related to the implement 12 being towed by the work vehicle 10. For example, data related to the implement's type, model, geometric configuration and/or other data associated with the implement 12 may be stored within the implement database 120. Specifically, in one embodiment, the implement database 120 may include data or other information associated with the obstacle collision zone 60 for the implement 12, such as information related to the geometry of the implement 12, information related to the location of relevant components of the implement 12 when in the work and transport positions and/or information related to the folding/unfolding sequences for the implement 12.

Moreover, in several embodiments, the memory 112 may also include an operating mode database 122 storing information associated with one or more operating modes that can be utilized when executing one or more of the control functions described herein. For instance, the disclosed system 100 and related methods may be configured to be executed using one or more different operating modes depending on any number of factors, such as the relative location of the operator, whether the work vehicle 10 is autonomous (as opposed to being manually controlled), and the capability of the controller 102 to automatically analyze the associated vision-related data.

Specifically, in one embodiment, suitable data may be stored within the operating mode database 122 for executing an operator-supervised control mode in which the vision-related data is transmitted to a display device 108 accessible to the operator to allow such operator to visually assess the data and make a determination as to whether any obstacles are present that could result in a collision with the implement 12 during the performance of a given wing movement operation (e.g., folding or unfolding of the wing assemblies 36, 38). In such an embodiment, the controller 102 may be configured to transmit the data locally or remotely depending on the location of the operator and/or the associated display device 108. For instance, for an operator located within the cab 22 of the work vehicle 10, the controller 102 may be configured to transmit the data to the display device located within the cab 22 for presentation to the operator. Alternatively, the display device may form part of or may otherwise be coupled to a separate computing device accessible to the operator, such as a handheld device carried by the operator (e.g., a smartphone or a tablet) or any other suitable remote computing device (e.g., a laptop, desktop or other computing device located remote to the vehicle/implement).

In addition to the operator-supervised control mode (or as an alternative thereto), suitable data may be stored within the operating mode database 122 for executing an unsupervised or automated control mode in which the vision-related data is automatically analyzed by the controller 102 to allow a determination to be made as to whether any obstacles are present that could result in a collision with the implement 12 during the performance of a given wing movement operation (e.g., folding or unfolding of the wing assemblies 36, 38). For example, as will be described in greater detail below, the controller 102 may be configured to analyze the data using a suitable computer-vision technique to allow the required determination to be made.

Referring still to FIG. 4, in several embodiments, the instructions 116 stored within the memory 112 of the controller 102 may be executed by the processor(s) 110 to implement a data transmission module 124. In general, the data transmission module 124 may be configured to receive the vision-related data from the vision sensor(s) 104 and process such data for subsequent transmission to one or more devices. For instance, when the controller 102 is operating in the operator-supervised control mode, the data transmission module 124 may be configured to receive the vision-related data from the vision sensor(s) 104, and subsequently transmit the data for presentation to the operator via the associated display device 108. In such an embodiment, the manner in which the data is transmitted by the data transmission module 126 may vary depending on location of the display device 108 being accessed by the operator. For example, for a display device located within the cab, the data transmission module 124 may be configured to transmit the data via a wired connection (e.g., as indicated by line 126), such as via any suitable communicative link provided within the work vehicle 10 and/or any data bus or other suitable connection providing a communicative link between the implement 12 and the work vehicle 10. Alternatively, for a display device 108 associated with a separate computing device (e.g., a handheld device or any other remote device), the data transmission module 124 may be configured to transmit the data via any suitable network 128, such as a local wireless network using any suitable wireless communications protocol (e.g., WiFi, Bluetooth, and/or the like) and/or a broader network, such as a wide-area network (WAN), using any suitable communications protocol (e.g., TCP/IP, HTTP, SMTP, FTP).

Moreover, as shown in FIG. 4, the instructions 116 stored within the memory 112 of the controller 102 may also be executed by the processor(s) 110 to implement an obstacle detection module 130. In general, the obstacle detection module 130 may be configured to analyze the vision-related data received from the vision sensor(s) 104 using any suitable computer-vision technique or related algorithm. For instance, when the vision-related data includes images or other image data providing a view of all or a portion of the obstacle collision zone 60 of the implement 12, the obstacle detection module 130 may be configured to utilize any suitable image processing algorithm(s) that allows for the automatic detection of obstacles within the obstacle collision zone 60. Specifically, in several embodiments, the controller 102 may utilize a layout or template matching algorithm that utilizes reference images of the implement 12 as a basis for detecting foreign objects or obstacles within the images captured by the vision sensor(s) 104. For example, one or more reference obstacle-free images of the implement 12 (i.e., images without any obstacles or foreign objects depicted therein) may be stored within the controller's memory 112 that depict the wing assemblies 36, 38 at the work position, the transport position (e.g., the compact transport position shown in FIG. 2), and/or at one or more of the intermediate positions defined between the work and transport positions. In such an embodiment, by comparing the relevant reference image(s) to the image(s) captured by the vision sensor(s) 104, the controller 102 may determine whether any foreign objects or other obstacles are located within the sensor-based image(s). When an object or other obstacle is detected within such image(s), the controller 102 may then identify whether the obstacle is located within the obstacle collision zone 60 of the implement 12 to determine the potential for collision with the obstacle when actuating the wing assemblies 36, 38 between their work and transport positions.

It should be appreciated that, when executing the computer-vision technique, the controller 102 may also be configured to utilize any suitable machine learning technique to improve the efficiency and/or accuracy of detecting obstacles within the obstacle collision zone 60 of the implement 12. For instance, in one embodiment, the controller 102 may utilize a learning algorithm, such as neural network, to improve its obstacle detection capabilities over time. It should also be appreciated that, in other embodiments, the obstacle detection module 130 may be configured to utilize any other suitable computer-vision technique for detecting obstacles, such as pattern matching, feature extraction, and/or the like.

Referring still to FIG. 4, the instructions 116 stored within the memory 112 of the controller 102 may also be executed by the processor(s) 110 to execute a wing control module 132. In general, the wing control module 132 may be configured to control the operation of the various actuators 34, 51, 52 of the implement 12, thereby allowing the controller 102 to automatically adjust the position of the wing assemblies 36, 38 between their work and transport positions. For instance, as shown in FIG. 4, the controller 102 may be communicatively coupled to one or more control valves 134 configured to regulate the supply of fluid (e.g., hydraulic fluid or air) to the various actuators 34, 51, 52 of the implement 12. In such an embodiment, by regulating the supply of fluid to the actuator(s) 34, 51, 52, the controller 102 may automatically adjust the position of the wing assemblies 36, 38 relative to the ground and/or relative to the central toolbar 30.

In several embodiments, the wing control module 132 may only be configured or permitted to actuate the wing assembles 36, 38 after a determination has been made that such movement of the wing assembles 36, 38 can be performed without colliding into any potential obstacles located at or adjacent to the implement 12. For example, when a request is received to unfold the wing assembles 36, 38 from their compact transport position to their work position, the controller 102 may initially determine whether the requested operation can be performed without collision with any obstacles during the unfolding process (e.g., by transmitting the vision-related data to the operator and receiving a response indicating that the operation can proceed or by automatically analyzing the vision-related data using the obstacle detection module 130). In the event that it is determined that the requested operation can be performed without collision with any obstacles, wing control module 132 may then be used to actuate the wing assembles 36, 38 in a manner that moves the assembles 36, 38 from their compact transport position to their work position. A similar sequence of events and related analysis can be performed in response to any other wing movement requests received by the controller 102, such as when a request is received to fold-up the wing assembles 36, 38 from their work position to their compact transport position or when a request is received to lower the wing assembles 36, 38 from their raised transport position to their work position.

Moreover, as shown in FIG. 4, the controller 102 may also include a communications interface 136 to provide a means for the controller 102 to communicate with any of the various other system components described herein. For instance, one or more communicative links or interfaces 138 (e.g., one or more data buses) may be provided between the communications interface 132 and the imaging device(s) 104 to allow images transmitted from the imaging device(s) 104 to be received by the controller 102. Similarly, one or more communicative links or interfaces 140 (e.g., one or more data buses) may be provided between the communications interface 132 and the control valves 134 to control the operation of such system components. Additionally, as indicated above, one or more communicative links or interfaces may be provided between the communications interface 132 and the display device 108 accessible to the operator, such as the wired connection 126 and/or the network 128.

Referring now to FIG. 5, a schematic view of a specific implementation of the system 100 described above with reference to FIG. 4 is illustrated in accordance with aspects of the present subject matter. Specifically, as shown, the system 100 includes both a vehicle controller 202A installed on and/or otherwise provided in operative association with the work vehicle 10 and an implement controller 202B installed on and/or otherwise provided in operative association with the implement 12. In general, each controller 202A, 202B of the disclosed system 100 may correspond to any suitable processor-based device(s), such as a computing device or any combination of computing devices. Thus, in several embodiments, the vehicle controller 202A may include one or more processor(s) 210A and associated memory device(s) 212A configured to perform a variety of computer-implemented functions, such as automatically controlling the operation of one or more components of the work vehicle 10. Similarly, as shown in FIG. 5, the implement controller 202B may also include one or more processor(s) 210B and associated memory devices 212B configured to perform a variety of computer-implemented functions, such as automatically controlling the operation of one or more components of the implement 12.

In addition, each controller 202A, 202B may also include various other suitable components, such as a communications circuit or module, a network interface, one or more input/output channels, a data/control bus and/or the like, to allow each controller 202A, 202B to be communicatively coupled to the other controller and/or to any of the various other system components described herein. For instance, as shown in FIG. 5, a communicative link or interface 240 (e.g., a data bus) may be provided between the vehicle controller 202A and the implement controller 202B to allow the controllers 202A, 202B to communicate with each other via any suitable communications protocol. Specifically, in one embodiment, an ISOBus Class 3 (ISO11783) interface may be utilized to provide a standard communications protocol between the controllers 202A, 202B. Alternatively, a proprietary communications protocol may be utilized for communications between the vehicle controller 202A and the implement controller 202B.

In general, the vehicle controller 202A may be configured to control the operation of one or more components of the work vehicle 10. For instance, in several embodiments, the vehicle controller 202A may be configured to control the operation of an engine 242 and/or a transmission 244 of the work vehicle 10 to adjust the vehicle's ground speed. Moreover, in several embodiments, the vehicle controller 202A may be communicatively coupled to a user interface 246 of the work vehicle 10. In general, the user interface 246 may include any suitable input device(s) configured to allow the operator to provide operator inputs to the vehicle controller 202A, such as a keyboard, joystick, buttons, knobs, switches, and/or combinations thereof located within the cab 22 of the work vehicle 10. In addition, the user interface 246 may include any suitable output devices for displaying or presenting information to the operator, such as a display device 108. In one embodiment, the display device 108 may correspond to a touch-screen display to allow such device to be used as both an input device and an output device of the user interface 246.

Referring still to FIG. 5, the implement controller 202B may generally be configured to control the operation of one or more components of the implement 12. For instance, in several embodiments, the implement controller 202B may be configured to control the operation of one or more components that regulate the actuation or movement of the wing assemblies 36, 38 of the implement 12. Specifically, as shown in FIG. 5, in one embodiment, the implement controller 202B may be communicatively coupled to one or more control valves 134 configured to regulate the supply of fluid (e.g., hydraulic fluid or air) to one or more of the various actuators 34, 51, 52 of the implement 12. In such an embodiment, by regulating the supply of fluid to each actuator(s) 34, 51, 52, the implement controller 202B may control the movement of the wing assemblies 36, 38 between their work position and their transport position.

It should be appreciated that, although the control valve(s) 134 is shown as being located on or otherwise corresponding to a component of the implement 12, the control valve(s) 134 may, instead, be located on or otherwise correspond to a component of the work vehicle 10. For instance, when the control valve(s) 134 is located on the work vehicle 10, a fluid coupling(s) may be provided between the control valve(s) 134 and one or more of the implement actuator(s) 34, 51, 52 as well as between the control valve(s) 134 and one or more actuators of the work vehicle 10. Additionally, in one embodiment, control valve(s) 134 may be provided in operative association with both the implement 12 and the work vehicle 10.

In several embodiments, the various control functions of the system 100 described above with reference to FIG. 4 may be executed entirely by either the vehicle controller 202A or the implement controller 202B. For instance, in one embodiment, the various databases 118, 120, 122 and modules 124, 130, 132 described above may be included entirely within and/or executed entirely by the vehicle controller 202A or the implement controller 202B.

Alternatively, the various control functions of the system 100 described above with reference to FIG. 4 may be distributed between the vehicle controller 202A and the implement controller 202B. Specifically, in several embodiments, one or more of the various databases 118, 120, 122 and/or modules 124, 130, 132 may be included within and/or executed by the vehicle controller 202A while one or more of the other databases 118, 120, 122 and/or modules 124, 130, 132 may be included within and/or executed by the implement controller 202B. For example, given that various different implements may be towed by the work vehicle 10, it may be desirable to include the implement database within the memory 212B of the implement controller 202B. In such an embodiment, data or other information associated with the implement 12 may be transmitted from the implement controller 202B to the vehicle controller 202A via the communicative link 240. Similarly, the installation location of the vision sensor(s) 104 may impact the initial storage location of the vision-related data. For example, in an embodiment in which the vision sensor(s) 104 is installed on the implement 12, the sensor database 118 may be located within the memory 212B of the implement controller 202B. In such an embodiment, the vision-related data received from the vision sensor(s) 104 may be communicated between the controllers 202A, 202B via the communicative link 240. For instance, assuming the vehicle controller 202A is configured to execute the data transmission module 124 and/or the obstacle detection module 130, the vision-related data acquired by the implement controller 202B from the vision sensor(s) 104 may be transmitted to the vehicle controller 202A for subsequent transmission to the operator's associated display device 108 and/or for subsequent analysis using a suitable computer-vision technique.

As indicated above, when operating in an operator-supervised control mode, the vision-related data may be transmitted to the operator for presentation on his/her associated display device 108. As shown in FIG. 5, when the display device 108 is located on the work vehicle 20 (e.g., within the cab 22), the vision-related data may be transmitted to the display device 108 directly from the vehicle controller 202A or indirectly from the implement controller 202B (e.g., via link 240). Similarly, to allow vision-related data to be transmitted to an associated display device 108 of a separate computing device (e.g., the handheld device 250 or the remote computing device 252 shown in FIG. 5), one or both of the controllers 202A, 202B may include a suitable communications device (not shown), such as a wireless antenna, to allow the controller(s) 202A, 202B to communicate wirelessly with such device(s) 250, 252 via any suitable network 128.

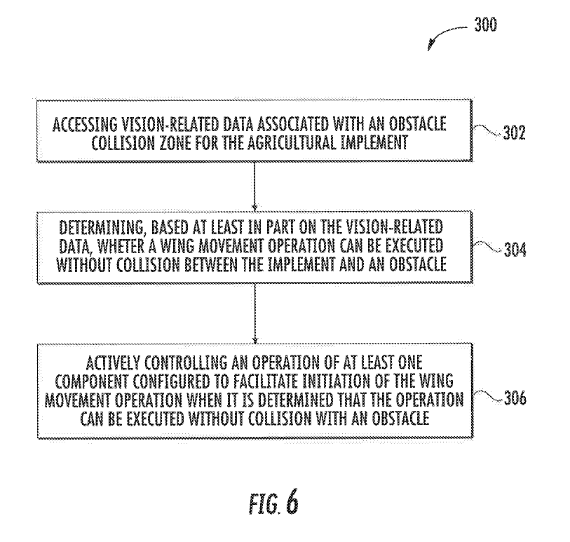

Referring now to FIG. 6, a flow diagram of one embodiment of a method 300 for avoiding obstacle collisions when actuating wing assemblies of an agricultural implement is illustrated in accordance with aspects of the present subject matter. In general, the method 300 will be described herein with reference to the work vehicle 10 and the implement 12 shown in FIGS. 1-3, as well as the various system components shown in FIG. 4. However, it should be appreciated that the disclosed method 300 may be implemented with work vehicles and/or implements having any other suitable configurations and/or within systems having any other suitable system configuration. For instance, although the control functions will generally be described as being executed by the controller 102 of FIG. 4, the control functions may, instead, be executed by the vehicle controller 202A and/or the implement controller 202B of FIG. 5, including such functions being distributed across both controllers 202A, 202B. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (302), the method 300 may include accessing vision-related data associated with an obstacle collision zone for the agricultural implement. Specifically, as indicated above, the controller 102 may be communicatively coupled to one or more vision sensors 104 having a field of view 106 encompassing all or a portion of the obstacle collision zone 60 for the implement 12. As such, the vision-related data acquired by the vision sensor(s) 104 may be transmitted from the sensor(s) 104 to the controller 102 and stored within the controller's memory 112.

Additionally, at (304), the method 300 may include determining, based at least in part on the vision-related data, whether a wing movement operation can be executed without collision between the implement and an obstacle. Specifically, in several embodiments, the vision-related data may be analyzed or assessed to determine whether any obstacles are present within the portion of the obstacle collision zone 60 across which the wing assemblies 36, 38 will be moved during performance of the wing movement operation. If such portion of the obstacle collision zone 60 is free from obstacles, it may be determined that the wing movement operation can be performed without any potential collisions. However, if an obstacle(s) is present within the portion of the obstacle collision zone 60 across which the wing assemblies 36, 38 will be moved, it may be determined that the wing movement operation should not be performed to avoid a potential collision with the identified obstacle(s).

As indicated above, the manner in which the controller 102 determines whether the wing movement operation can be executed without collision with an obstacle may vary depending on the operating mode being implemented by the controller 102. For instance, when operating in an operator-supervised control mode, the controller 102 may make such a determination based on inputs or other instructions received from the operator (e.g., by receiving an input from the operator instructing the controller 102 to proceed with performing the operation. Alternatively, when operating in an unsupervised or automated control mode, the controller 102 may automatically determine whether the wing movement operation should be performed based on result of its computer-vision-based analysis of the vision-related data.

Moreover, as shown in FIG. 6, at (306), the method 300 may include actively controlling an operation of at least one component configured to facilitate initiation of the wing movement operation when it is determined that the operation can be executed without collision with an obstacle. Specifically, as indicated above, the controller 102 may be configured to actively control the operation of one or more of the actuators 34, 51, 52 of the implement 12 and/or the work vehicle 10 to actuate the wing assemblies 36, 38 in a manner consistent with the operation being performed. For instance, to execute an unfolding sequence for the wing assemblies 36, 38, the controller 102 may be configured to control the implement actuators 34, 51, 52 such that the wing assemblies 36, 38 are moved from their compact transport position to their work position. Similarly, to execute a folding sequence for the wing assemblies 36, 38, the controller 102 may be configured to control the implement actuators 34, 51, 52 such that the wing assemblies 36, 38 are moved from their work position to their compact transport position.

It should be appreciated that, in several embodiments, following initiation of the wing movement operation, the vision-related data may continue to be analyzed or assessed (e.g., visually by the operator and/or automatically by the controller 102) to determine whether the obstacle collision zone 60 remains free of obstacles as the wing movement operation is being performed. For instance, it may be desirable to continue to assess or analyze the vision-related data to ensure that a person or animal does not move into the obstacle collision zone 60 following initiation of the wing operation movement. In the event that an obstacle is detected within the obstacle collision zone 60 during the performance of the wing movement operation, the operation may be terminated to prevent collision with the newly detected obstacle. For example, the controller 102 may be configured to terminate the operation based on a suitable input received from the operator or the controller 102 may be configured to terminate the operation automatically based on the detection of the obstacle. In one embodiment, the wing movement operation may be terminated by halting active motion of the wing assemblies 36, 38 and/or by preventing further motion of the wing assemblies 36, 38.

In addition to terminating the operation upon the detection of an obstacle within the obstacle collision zone 60 (or as an alternative thereto), the controller 102 may be configured to transmit a notification providing the operator an indication that an obstacle has been detected. For instance, the controller 102 may be configured to generate an visual notification (e.g., a fault message to be displayed to the operator via the display device) or an audible notification (e.g., a chime or warning sound).

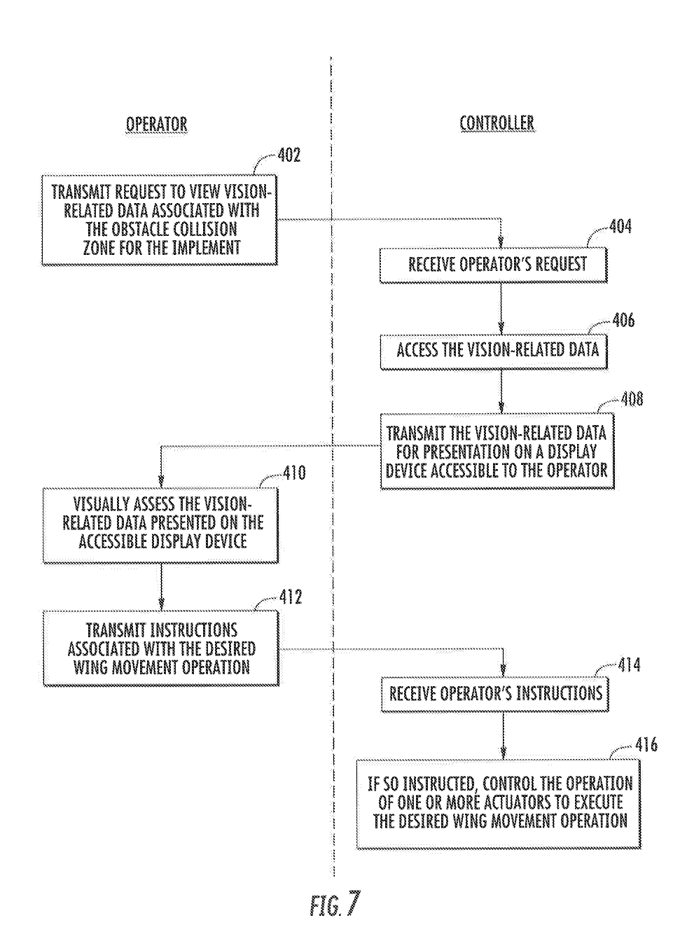

Referring now to FIG. 7, a flow diagram of a specific implementation of the method 300 described above with reference to FIG. 6 is illustrated in accordance with aspects of the present subject matter. Specifically, the method 300 will be described with reference to FIG. 7 assuming that the controller 102 is functioning in an operator-supervised mode in which the controller 102 is configured to transmit the vision-related data to a display device 108 accessible by the operator. It should be appreciated that, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (402), the operator may initially transmit a request to view vision-related data associated with the obstacle collision zone 60 of the implement 12 to allow the operator to assess whether a given wing movement operation can be performed without collision with any obstacles. For example, the operator may desire for an operation to be executed that is associated with moving at least one of the wing assemblies 36, 38 between its work and transport positions, such as a complete folding sequence to move the wing assemblies 36, 38 from their work position to their compact transport position or a complete unfolding sequence to move the wing assemblies 36, 38 from their compact transport position to their work position. In one embodiment, the operator's request may be made via a suitable input device located within the cab 22 of the work vehicle 10. Alternatively, the request may be made remotely by the operator via a wireless connection between the controller 102 and a separate computing device accessible to the operator (e.g., the handheld device 250 or remote device 252 shown in FIG. 5).

At (404), the operator's data request may be received and processed by the controller 102. Thereafter, at (406), the controller 102 may be configured to access the vision-related data transmitted from the vision sensor(s) 104. For instance, in embodiments in which the vision sensor(s) 104 is configured to continuously capture vision-related data associated with the obstacle collision zone 60 of the implement 12, the controller 102 may be configured to simply access the most-recent data received from the sensor(s) 104. Alternatively, if the vision sensor(s) 104 is configured to capture vision-related data on demand, the controller 102 may be configured to initiate such data capture by the sensor(s) 104 to allow the data to be subsequently transmitted to and received by the controller 102. Upon receipt, the vision-related data may then be accessed by the controller 102.

Additionally, as shown in FIG. 7, at (408), the controller 102 may be configured to transmit the vision-related data for presentation on a display device 108 accessible to the operator. For instance, as described above, the controller 102 may be configured to transmit the data to a display device 108 located within the cab 22 of the work vehicle 10 or to a display device 108 associated with a separate computing device accessible to the operator (e.g., the handheld device 250 or the remote computing device 252 shown in FIG. 5). Thereafter, at (410), the vision-related data may be presented on the display device to allow the operator to visually assess the implement's obstacle collision zone 60 for any obstacles that would make it undesirable to perform the intended wing movement operation (e.g., due to safety issues or the potential for damage to the implement 12). For example, when the vision-related data corresponds to an image(s) of the implement 12 and/or the area surrounding the implement 12, the operator may view the image(s) to assess whether any obstacles appear to be located within the obstacle collision zone 60 of the implement 12. Based on such assessment, the operator may, at (414), transmit appropriate instructions to the controller 102 associated with performing the desired wing movement operation. For example, if the operator identifies that an obstacle is present at a location within the obstacle collusion zone 60 (i.e., such that the obstacle will be contacted by the implement during performance of the desired operation), the operator may instruct the controller 102 to not proceed with performing the operation. Alternatively, if the operator's visual assessment of the vision-related data indicates that the obstacle collision zone 60 is free of obstacles, the operator may instruct the controller 102 to proceed with performing the operation.

As shown in FIG. 7, upon receipt of the operator's instructions at (414), the controller 102 may execute any suitable control action(s) necessary to proceed as instructed by the operator. For example, if the operator instructs the controller 102 to not proceed with the desired operation, the controller 102 may be configured to take no further action if such operation had not yet been initiated. Otherwise, the controller 102 may be configured to abort or terminate the performance of the operation to comply with the operator's instructions. Alternatively, if the operator instructs the controller 102 to proceed with the desired operation, the controller 102 may, at (416), be configured to control the operation of the relevant actuators 34, 51, 52 of the implement 12 to move the wing assemblies 36, 38 as requested. For example, if the requested wing movement operation is associated with un-folding the wing assemblies 36, 38 from their compact transport position to their work position, the controller 102 may control the operation of the actuators 34, 51, 52 so as to perform the desired unfolding sequence for the wing assemblies 36, 38.

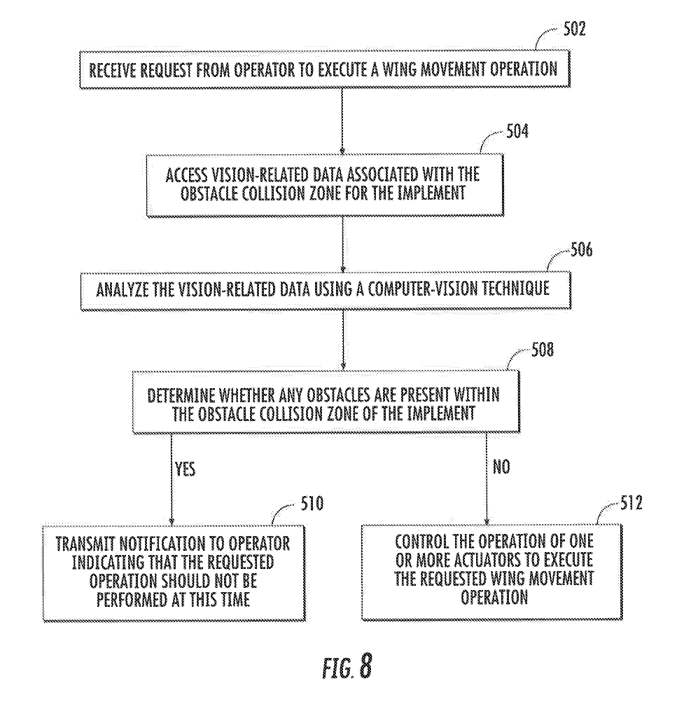

Referring now to FIG. 8, a flow diagram of another specific implementation of the method 300 described above with reference to FIG. 6 is illustrated in accordance with aspects of the present subject matter. Specifically, the method 300 will be described with reference to FIG. 8 assuming that the controller 102 is functioning in an unsupervised or automated mode in which the controller 102 is configured to automatically analyze the vision-related data received from the vision sensor(s) 104. It should be appreciated that, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (502), the controller 102 may initially receive a request from the operator to execute a wing movement operation associated with moving at least one of the wing assemblies 36, 38 of the implement 12 between its work and transport positions. For example, the operator may request that the controller 102 perform a complete folding sequence in which the wing assemblies 36, 38 are moved from their work position to their compact transport position or a complete unfolding sequence in which the wing assemblies 36, 38 are moved from their compact transport position to their work position. In one embodiment, the operator's request may be received from a suitable input device located within the cab 22 of the work vehicle 10. Alternatively, the request may be received over a network from a separate computing device accessible to the operator (e.g., the handheld device 250 or the remote computing device 252 shown in FIG. 5).

At (504), the controller 102 may be configured to access the vision-related data transmitted from the vision sensor(s) 104. For instance, in embodiments in which the vision sensor(s) 104 is configured to continuously capture vision-related data associated with the obstacle collision zone 60 of the implement 12, the controller 102 may be configured to simply access the most-recent data received from the sensor(s) 104. Alternatively, if the vision sensor(s) 104 is configured to capture vision-related data on demand, the controller 102 may be configured to initiate such data capture by the sensor(s) 104 to allow the data to be subsequently transmitted to and received by the controller 102. Upon receipt, the vision-related data may then be accessed by the controller 102.

Thereafter, at (506), the controller 102 may be configured to analyze the vision-related data using any suitable computer-vision technique, such as a suitable image processing algorithm or any other suitable computer-vision algorithm that allows for the detection of obstacles located adjacent to the implement 12. Based on the analysis, the controller 102 may, at (508), determine whether any obstacles are present within the relevant portion of the obstacle collision zone 60 to be traversed by the wing assemblies 36, 38 assuming that the requested operation is performed. In the event that an obstacle(s) is present within such portion of the implement's obstacle collision zone 60, the controller 102 may determine that the requested operation should not be performed. In such instance, the controller 102 may, at (510), transmit a notification to the operator indicating that the requested operation should not be performed at this time due to the likelihood of collision with an obstacle. Alternatively, if the controller 102 determines that the relevant portion of the obstacle collision zone 60 is free from obstacles, the controller 102 may, at (512), control the operation of the implement's actuators 34, 50, 51 to execute the requested operation. For example, the controller 102 may be configured to control the operation of the associated control valves 134 to regulate the flow of fluid to the actuators 34, 50, 51, thereby allowing the controller 102 to control the movement of the wing assemblies 36, 38.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for avoiding collisions when actuating wing assemblies of an agricultural implement, the method comprising:
accessing, with one or more computing devices, vision-related data associated with an obstacle collision zone for the agricultural implement;
determining, with the one or more computing devices, whether a wing movement operation can be executed without collision between the agricultural implement and an obstacle based at least in part on the vision-related data, the wing movement operation being associated with moving at least one wing assembly of the agricultural implement across at least a portion of the obstacle collision zone between a work position of the at least one wing assembly and a transport position of the at least one wing assembly; and
when it is determined that the wing movement operation can be executed without collision, actively controlling, with the one or more computing devices, an operation of at least one component configured to facilitate initiation of the wing movement operation.

2. The method of claim 1, wherein accessing the vision-related data comprises accessing the vision-related data received from at least one vision sensor having a field of view encompassing at least a portion of the obstacle collision zone for the agricultural implement.

3. The method of claim 2, wherein the at least one vision sensor comprises at least one of a camera, a radar device, a LIDAR device, or an ultrasound sensor.

4. The method of claim 2, wherein the at least one vision sensor is installed on at least one of the agricultural implement or a work vehicle configured to tow the agricultural implement.

5. The method of claim 1, further comprising receiving a request to execute the wing movement operation from an operator of the agricultural implement.

6. The method of claim 1, further comprising automatically analyzing, with the one or more computing devices, the vision-related data using a computer-vision technique to detect the presence of an obstacle within the obstacle collision zone.

7. The method of claim 5, wherein determining whether the wing movement operation can be executed without collision comprises determining, via the analysis performed using the computer-vision technique, whether an obstacle has been detected within a portion of the obstacle collision zone that will be traversed by the at least one wing assembly during the execution of the wing movement operation.

8. The method of claim 1, wherein the vision-related data comprises images depicting at least a portion of the obstacle collision zone for the agricultural implement, wherein automatically analyzing vision-related data using a computer-vision technique comprises automatically analyzing the vision-related data using an image processing algorithm that allows for the detection of obstacles within the images.

9. The method of claim 1, further comprising transmitting, with the one or more computing devices, the vision-related data for presentation on a display device accessible to an operator.

10. The method of claim 9, wherein determining whether the wing movement operation can be executed without collision comprises receiving instructions from the operator to initiate the wing movement operation.

11. The method of claim 9, wherein the display device is disposed within a cab of a work vehicle towing the agricultural implement or the display device is associated with a separate computing device accessible to the operator.

12. The method of claim 1, further comprising detecting the presence of an obstacle within the obstacle collision zone of the implement after initiation of the wing movement operation.

13. The method of claim 12, further comprising terminating the performance of the wing movement operation upon the detection of the presence of the obstacle within the obstacle collision zone of the implement.

14. A system for avoiding collisions when actuating implement wing assemblies, the system comprising:
an agricultural implement including at least one wing assembly configured to be moved between a work position and a transport position;
at least one vision sensor configured to acquire vision-related data associated with an obstacle collision zone for the agricultural implement; and
a controller communicatively coupled to the at least one vision sensor, the controller including a processor and associated memory, the memory storing instructions that, when executed by the processor, configure the controller to:
access the vision-related data received from the at least one vision sensor;
determine whether a wing movement operation can be executed without collision between the agricultural implement and an obstacle based at least in part on the vision-related data, the wing movement operation being associated with moving the at least one wing assembly across at least a portion of the obstacle collision zone defined between the work and transport positions; and
when it is determined that the wing movement operation can be executed without collision, actively control an operation of at least one component configured to facilitate initiation of the wing movement operation.

15. The system of claim 14, wherein the at least one vision sensor has a field of view encompassing at least a portion of the obstacle collision zone for the agricultural implement.

16. The system of claim 15, wherein the at least one vision sensor comprises at least one of a camera, a radar device, a LIDAR device, or an ultrasound sensor.

17. The system of claim 15, wherein the at least one vision sensor is installed on at least one of the agricultural implement or a work vehicle configured to tow the agricultural implement.

18. The system of claim 14, wherein the controller is further configured to automatically analyze the vision-related data using a computer-vision technique to detect the presence of an obstacle within the obstacle collision zone, the controller being configured to determine whether the wing movement operation can be executed without collision by determining, via the analysis performed using the computer-vision technique, whether an obstacle has been detected within a portion of the obstacle collision zone that will be traversed by the at least one wing assembly during the execution of the wing movement operation.

19. The system of claim 14, wherein the controller is further configured to transmit the vision-related data for presentation on a display device accessible to an operator, the controller being configured to determine whether the wing movement operation can be executed without collision based on instructions received from the operator.

20. The method of claim 19, wherein the display device is disposed within a cab of a work vehicle towing the agricultural implement or the display device is associated with a separate computing device accessible to the operator.
